(19) United States
(12) Patent Application Publication
(10) Pub. No.: US 2024/0224179 A1
(43) Pub. Date: Jul. 4, 2024

(54) RADIO WAKE-UP FOR RADIO CONTROL OF ELECTRONIC DEVICES

(71) Applicant: Microchip Technology Incorporated, Chandler, AZ (US)

(72) Inventor: Frank Aloe, Brooklin (CA)

(73) Assignee: Microchip Technology Incorporated, Chandler, AZ (US)

(21) Appl. No.: 18/144,280

(22) Filed: May 8, 2023

Related U.S. Application Data
(60) Provisional application No. 63/435,888, filed on Dec. 29, 2022.

(51) Int. Cl. H04W 52/02; H04W 76/10

(52) U.S. Cl. CPC H04W 52/0229; H04W 76/10

(57) ABSTRACT

Methods, devices, and systems that pair a first device so a radio control circuit of the second device may store first device identification information, operate a host circuit of the second electronic device in a sleep mode, detect by the radio control circuit of the second device a radio advertisement signal from the first device, and wake up the host circuit of the second device from the sleep mode, and establish a control link between the first device and the host circuit of the second device.

### PRIORITY

The present application claims priority to U.S. Provisional Patent Application No. 63/435,888 filed Dec. 29, 2022, the contents of which are hereby incorporated in their entirety.

### TECHNICAL FIELD

The present disclosure relates remote control of electronic devices, in particular, waking up an electronic device responsive to a radio advertisement signal and controlling the electronic device with radio control signals.

### BACKGROUND

In system on chip (SOC) electronic devices, a radio module such as a Bluetooth® low energy (BLE) module may comprise a radio controller such as a BLE controller, a host, and an application. In such electronic devices, the radio controller (e.g., BLE controller) may listen for a radio advertisement from a remote controller, such as a smartphone, without limitation, to awaken the electronic device from a low-power mode to a high-power mode.

In other electronic devices a microprocessor unit (MPU), separate from the radio controller, e.g., separate from the BLE controller, may control low-power modes of operation including wake-up via a physical POWER switch or a separate infrared (IR) remote controller. The MPU may comprise an operating system such as Linux, a radio host stack such as Bluetooth® low energy (BLE) or Wi-Fi®, and an application. Example electronic devices include music servers, appliances, audio devices, video devices (televisions), and line powered electronic devices.

A typical electronics system has an electronic device (having a microprocessor unit with a Linux operating system), which is responsive to commands from a remote controller, such as a smart-phone, without limitation, through the BLE stack. The electronic device is woken-up from a low-power, standby mode by either: (1) pressing a physical POWER button on the electronic device itself; or (2) sending an infrared signal via an infrared remote controller. An electronic device has to be awake to listen for BLE commands from a smartphone, since in low-power or standby mode the radio host stack is powered off, in order to reach a standby power of less than 0.5 W (UL). After the electronic device is awake and operating in a high-power mode, including powering up the host radio stack, the smartphone may communicate with the electronic device via radio signals to control the electronic device.

Alternatively, electronic devices may be controlled by the MPU to operate in a high-power mode continuously, i.e., it remains fully powered all the time, to allow for smartphone control link connectivity on demand. However, operating in a high-power mode continuously does not provide any power savings for the electronic device.

There is a need for electronic devices to be woken-up, turned ON, or fully powered-up by a remote controller, such as a smart-phone, without limitation, without the user pressing a physical POWER switch on the electronic device or using a separate infrared remote control to wake-up the electronic device from a low-power standby mode.

### SUMMARY OF THE INVENTION

Aspects provide systems, devices, and methods that wake-up an electronic device by a remote controller advertisement signal so the remote controller, such as a smart-phone, without limitation, may then establish a control link with the electronic device.

According to an aspect, there is provided a method comprising: establishing communications between a first device having first device identification information with a second device having a radio control circuit and a host circuit, wherein the first device identification information is communicated to and stored by the radio control circuit of the second device; operating the second electronic device in a sleep mode which maintains operational power to the radio control circuit without maintaining operational power to the host circuit; detecting by the radio control circuit of the second device an advertisement signal from the first device containing the first device identification information; and waking up the second device from the sleep mode, in response to detecting the advertisement signal, to operate in an awake mode which maintains operational power to both the radio control circuit and host circuit, wherein in the awake mode the first device is capable of establishing a control link with the host circuit of the second device.

An aspect provides a device comprising: a radio antenna; a microprocessor in signal communication with the radio antenna and comprising: a radio control circuit in communication with the radio antenna to store identification information of a remote controller and detect an advertising signal from a remote controller containing identification information of the remote controller; and a host circuit in communication with the radio antenna to establish a control link with the remote controller; wherein the device is operable in a low-power mode wherein operational power is maintained to the radio control circuit and not maintained to the host circuit, wherein the device is operable in a high-power mode wherein operational power is maintained to both the radio control circuit and the host circuit, and wherein the device switches from the low-power mode to the high-power mode in response to detection, by the radio control circuit, of an advertising signal containing the identification information of the remote controller.

According to an aspect there is provided a system comprising: a remote controller having remote controller identification information; and an line powered electronic device comprising: a radio antenna; a radio control circuit in communication with the radio antenna, the radio control circuit to store identification information of a remote controller and detect an advertising signal from a remote controller containing the identification information; a host circuit in communication with the radio antenna, the host circuit to establish a control link with the remote controller; wherein the radio control circuit to wake-up the host circuit in response to detection, by the radio control circuit, of an advertising signal containing the remote controller identification information.

### BRIEF DESCRIPTION OF THE DRAWINGS

The figures illustrate examples of systems, devices and methods that wake-up an electronic device by a smartphone advertisement signal so the smartphone may then establish a control link with the electronic device without the user pressing a physical POWER switch on the electronic device or using a separate IR remote control to wake-up the electronic device from a low-power standby mode.

FIG. 1 shows a block diagram of an electronic device and a remote controller, wherein the electronic device has a radio control circuit and a host circuit.

FIG. 2 shows a block diagram of an electronic device and a remote controller, wherein the electronic device has a radio control circuit with a BLE controller, and a microprocessor with a host circuit.

FIG. 3 shows a block diagram of an electronic device and a remote controller, wherein the electronic device has a radio antenna and a microprocessor with a radio control circuit and a host circuit.

FIG. 4 shows a block diagram of an electronic device and a remote controller, wherein the electronic device has a radio control circuit and a host circuit.

FIG. 5 shows a schematic diagram of an electronic device having a radio antenna, a radio control circuit, and a microprocessor with a host circuit.

FIG. 6 shows a schematic diagram of an electronic device having a radio antenna and a microprocessor with a radio control circuit and a host circuit.

FIG. 7 shows flow chart of a method for pairing devices, operating a device in sleep mode, detecting an advertising signal, and waking a device to establish a control link between devices.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

Aspects provide systems, devices and methods that wake-up an electronic device by a remote controller, such as a smartphone, radio advertisement signal so the smartphone may then establish a control link with the electronic device without the user pressing a physical POWER switch on the electronic device or using a separate infrared (IR) remote control to wake-up the electronic device from a low-power standby mode. Aspects of this disclosure provide a radio control circuit of an electronic device that listens to a radio advertisement signal from a remote controller, compares identification information in the radio advertisement signal to a stored list of identification information for remote controllers, and wakes-up the electronic device so that a confirmed remote controller may establish a control link with the electronic device.

Aspects provide an electronic device that wakes itself up from a sleep mode when it detects and recognizes an radio advertisement signal from a previously paired smartphone. When a previously paired smartphone is not detected by the electronic device, the electronic device may remain in the sleep mode to save power. When a previously paired smartphone is detected, the electronic device may be triggered to wake-up to an awake mode in which the electronic device can be fully controlled by the smartphone. The smartphone may then act as a remote controller for the electronic device.

The signal from a remote controller to an electronic device may be a wireless signal selected from the group consisting of Bluetooth®, Wi-Fi®, and ZigBee®. Further, the wireless signal may be formatted in accordance with at least one communications standard selected from the group consisting of Bluetooth®, Wi-Fi®, and Zigbee®. Bluetooth® is a registered trademark owned by the Bluetooth® SIG. Wi-Fi® is a registered trademark owned by the Wi-Fi Alliance. ZigBee® is a registered trademark owned by the ZigBee Alliance.

The remote controller may be any device capable of providing control commands, such as a smart-phone, without limitation. In some aspects, a radio antenna of the electronic device may communicate with the remote controller. The radio antenna of the electronic device may be used to communicate with a user device (remote controller) capable of remotely controlling the electronic device, which may include dedicated remote controls, smartphones, tablet computers, laptop computers, or any other user device capable of interfacing with the radio antenna of the electronic device. These communications may be direct or through a local area network, such as a homeowner's network (e.g., via Wi-Fi), which may further include access to a central server, such as a cloud based server. In other aspects, communications may be via a local communications hub or bridge. Communications may be directly with a central or cloud-based server (e.g., via a cellular connection). In other aspects, communications may be directly between the remote controller and the electronic device. Remote controllers may include without limitation: iPhone, iPad, Android, and Blackberry personal digital assistant. Such devices may use a mobile device platform, including without limitation: Java, Java ME, iPhone, iOS, iPad, Android, Windows Mobile, Windows Phone, Blackberry OS, Symbian, bada, and others. Remote controllers may be capable of local wireless communication, such as without limitation: Wi-Fi (e.g. 802.11x); Wi-Max; cellular (e.g. 3G, 4G, LTE, CDMA, etc.); LoRa; Zigbee; Zigbee Pro; Bluetooth; Bluetooth Low Energy (BLE), which includes Bluetooth 4.0 protocol currently implemented on the iOS®5+ and Android® OS 4.3+ operating systems; Near Field Communication (NFC); Z-Wave, 6LoWPAN; Thread; RFID; and other applicable wireless protocols. In one particular example, the remote controller is an application running on a smartphone, the smartphone communicating with the electronic device through BLE.

Electronic devices may be switched from a low-power mode, upon detection of an radio advertisement signal from a previously paired smartphone. An electronic device may be switched to high-power modes when an radio advertisement signal of a previously paired smartphone is detected, which may then allow for connection of the smartphone for remote controller capability.

The remote controller may establish communications via a radio advertisement signal, such as a BLE advertisement signal, without limitation. An aspect is to detect a BLE advertisement signal from a previously paired smartphone and use this detection to trigger a wake-up of a microprocessor unit in an electronic device. One aspect may provide the microprocessor unit with a very simple Bluetooth® low energy (BLE) function that listens for advertisements and if it detects a BLE advertisement signal of a previously paired smartphone, it will create a wake-up signal (either a pin toggle or UART message). Another aspect provides a sub-function in the BLE module of a microprocessor unit that powers down functions except for BLE advertisement listening. This function can then listen for BLE advertisement signals and wake-up the rest of the microprocessor system if a BLE advertisement signal from a previously paired smartphone is detected. This listen and wakeup functionality can be provided in the host controller interface (HCI) level of a radio control circuit, which can then be used as part of an MPU Linux sub system.

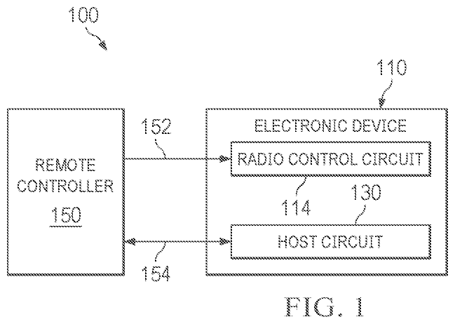

FIG. 1 shows a block diagram of a system 100 having an electronic device 110 and a remote controller 150. The electronic device 110 has a radio control circuit 114 and a host circuit 130. The remote controller 150 transmits a radio advertisement signal 152 to the radio control circuit 114. The remote controller 150 may also establish a control link 154 via radio signals with the host circuit 130 of the electronic device 110. The electronic device 110 may be any electronic device such as music servers, appliances, audio devices, video devices (televisions), and line powered electronic devices. The remote controller 150 may be a smartphone, such as an iPhone or Android based device. In one aspect, a Bluetooth Low Energy stack may be split into two different layers: the Bluetooth Low Energy Controller and the Bluetooth Low Energy Host. In FIG. 1, the radio control circuit 114 may be a Bluetooth Low Energy Controller and the host circuit 130 may be a Bluetooth Low Energy Host. These software subsystems can be run either on the same IC or on two separate ICs that may be connected through a physical serial interface and the standard Host Controller Interface (HCI) protocol.

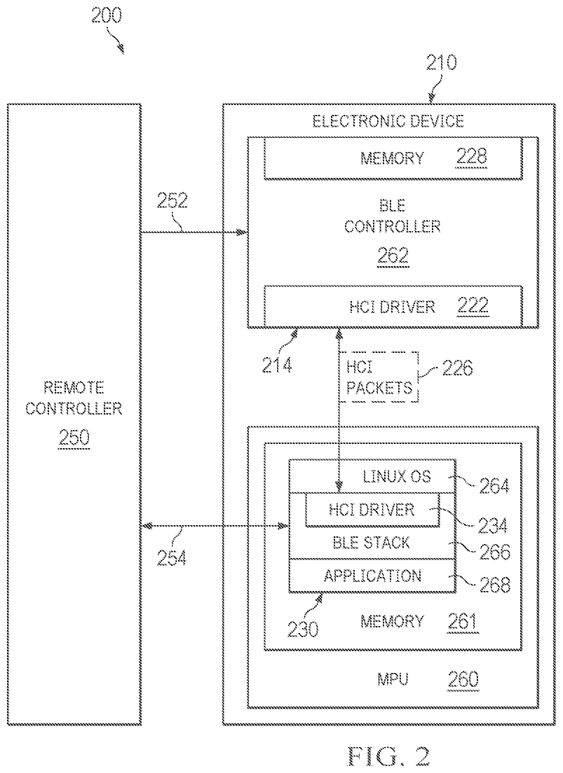

FIG. 2 shows a block diagram of a system 200 having an electronic device 210 and a remote controller 250. The electronic device 210 has a microprocessor 260 and a radio control circuit 214, e.g., a BLE controller 262. The microprocessor 260 has an operating system 264, a host circuit 230, e.g., a BLE stack 266, and an application 268 in a memory 261. The remote controller 250 transmits a radio advertisement signal 252 to the BLE controller 262. The remote controller 250 may also establish a control link 254 via radio signals with the BLE Stack 266 of the electronic device 210. Bluetooth has several protocol layers which form the Bluetooth protocol stack. The lower layers are in the BLE controller 262, which contains the radio interface. The upper layers are in a BLE stack 266, which deals with the high level data. As shown in FIG. 2, the BLE controller 262 is outside the MPU 260. Alternatively, the BLE controller 262 may not be physically separate from the BLE stack 266. If physically separate, then a host controller interface (HCI) may handle communications between the BLE controller 262 and the BLE stack 266 via HCI packets 226. The BLE controller 262 may provide a host controller interface (HCI) level of a radio. In particular, the BLE controller 262 may have an HCI driver 222 and the BLE stack 266 may have an HCI driver 234, which communicate via HCI packets 226.

As shown in FIG. 2, the HCI driver 222 in the BLE controller 262 communicates with the HCI driver 234 in the BLE stack 226 of the microprocessor 260 and the BLE controller 262 may be designed to: listen for radio advertisement signals 252 from smartphones wherein the radio advertisement signals 252 contain smartphone identification information, compare detected identification information from advertisement signals to a stored list of identification information of previously paired smartphones, and output a wake-up signal to the BLE stack 266 when a previously paired smartphone is identified.

In a sleep mode, the MPU is powered OFF or asleep, or in a similar low power mode. The BLE controller 262 is not part of the MPU, and is powered so as to listen for BLE advertisement signals from a previously paired smartphone. The BLE controller 262 may listen continuously, or if the advertisements are once every 250 ms, the BLE controller 262 may sleep between those time intervals. For example, it may listen for 300 ms, and then go to sleep for 200 ms or more. The interface to the MPU 260 may operate according to a predefined standard called a host controller interface (HCI). A feature may be added to the BLE controller 262 to detect the presence of a previously paired device and use this detection to wake the MPU 260 from a sleep or off mode or a similar low power mode.

The BLE controller 262 of the electronic device 210 may remain powered ON while the MPU 260 is powered OFF or in a low-power sleep mode. Smartphone 250 may generate BLE advertising signals. The BLE controller 262 may listen for BLE advertisement signals from smartphone 250, while the MPU 260 remains in a low-power sleep mode. The BLE controller 262 may compare identification information from detected BLE advertisement signals to identification information of a stored list of previously paired smartphones. If a match is identified, the BLE controller 262 may issue a wake-up signal to the MPU 260. The MPU 260 may then power-up and be available for full BLE connection with the identified smartphone 250. The BLE controller 262 at this time may perform typical BLE operations to control the electronic device via command instructions transmitted via BLE signals transmitted by the identified remote controller.

The list of identification information for previously paired smartphones may be populated when individual smartphones are paired with the MPU 260, so that the BLE advertisement signals of those smartphones may be compared with the populated list. For example, an electronic device 210, such as a stereo, radio, television, or other consumer electron device, may be turned ON via a physical power button on the electronic device or push buttons on an infrared remote controller. The electronic device may then be paired with a smartphone 250 via radio signals. Once paired, the identification information, for example the MAC ID and other features, of the smartphone 250 may be stored in a memory 228 in the BLE controller 262 to populate a list of identification information for previously paired smartphones. Thereafter, when BLE controller 262 detects the BLE advertisement signal from a previously paired smartphone 250, even when the MPU 260 is in a low-power, stand-by mode, the BLE controller 262 can then power ON the MPU 260, and the BLE stack 266, once powered on, can connect the electronic device 210 with the smartphone 250 for full control capability via the smartphone 250.

The first time a smartphone 250 is paired with electronic device 210, pairing information may be saved by the electronic device 210 in BLE controller 262, or in a memory accessible by BLE controller 262. Detection of an advertisement signal from a previously paired smartphone may allow the smartphone 250 to control the fully powered electronic device 210. The user may then use a smartphone application to interface with the electronic device 210. Later, when the electronic device 210 is not being used and goes into a low power stand-by mode, the BLE controller 262 may remain active and may listen for BLE advertisement signals from the smartphone 250. If the previously paired smartphone 250 is detected by the electronic device 210, in particular by BLE controller 262, BLE controller 262 may trigger the electronic device to provide an internal signal from the BLE controller 262 to wake-up or power-up the entire electronic device 210, e.g., to wake-up or power-up MPU 260. This allows the electronic device 210 to stay in a low power mode according to standard standby protocols while enabling the electronic device 210 to be powered-up via the previously paired smartphone 250.

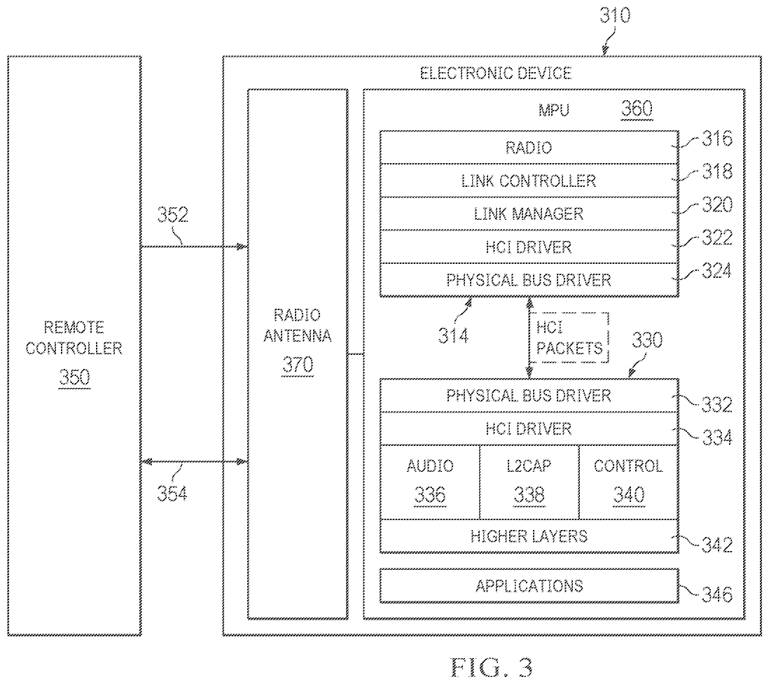

FIG. 3 shows a block diagram of a system 300 having an electronic device 310 and a remote controller 350. The remote controller 350 may be a Bluetooth Low Energy enabled smartphone. The electronic device 310 has a radio antenna 370 and a microprocessor 360. The microprocessor 360 has a radio control circuit 314, a host circuit 330, and applications 346. The radio control circuit 314 may include a protocol stack having layers identified as radio 316, a link control 318, a link manager 320, a host control interface (HCI) driver 322, and a physical bus driver 324. The host circuit 330 may also include a protocol stack having layers identified as a physical bus driver 332, an HCI driver 334, an audio 336, a logical link control and adaptation protocol (L2CAP) 338, a control 340, and higher layers 342. The protocol may be Bluetooth®, Wi-Fi®, ZigBee®, or a combination thereof. The remote controller 350 transmits a radio advertisement signal 352 to the radio control circuit 314. The remote controller 350 may also establish a control link 354 with the host circuit 330 through the radio antenna 370 and the radio control circuit 314.

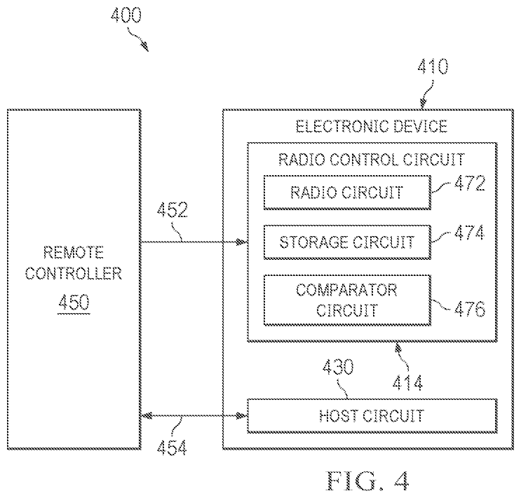

FIG. 4 shows a block diagram of a system 400 having an electronic device 410 and a remote controller 450. The remote controller 450 may be a Bluetooth Low Energy enabled smartphone. The electronic device 410 has a radio control circuit 414 and a host circuit 430. The radio control circuit 414 has a radio circuit 472, a storage circuit 474, and a comparator circuit 476. The radio circuit 472 may handle radio communications with the remote controller 450. The storage circuit 474 may store identification information for remote controllers 450 that have paired with the radio circuit 472. The comparator circuit 476 may compare identification information for remote controllers 450 sending radio advertisement signals to the radio circuit 472 with identification information for remote controllers stored in the storage circuit 474. The remote controller 450 transmits a radio advertisement signal 452 to the radio control circuit 414. The remote controller 450 may also establish a control link 454 via radio signals with the host circuit 430 of the electronic device 410.

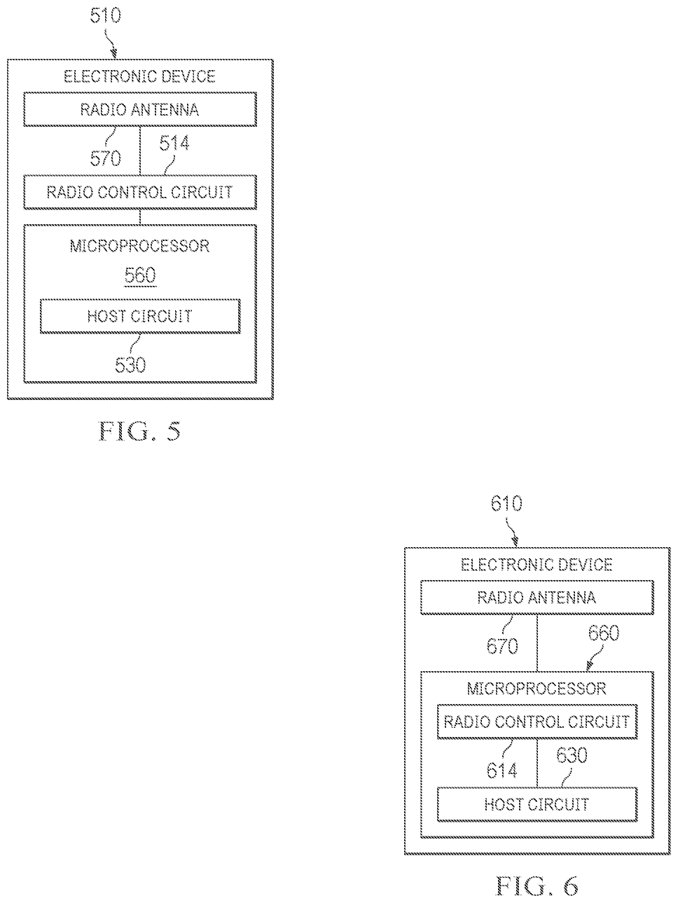

FIG. 5 shows a block diagram of an electronic device 510 having a radio antenna 570, a radio control circuit 514, and a microprocessor 560. The microprocessor 560 may have a host circuit 530. The microprocessor 560 and radio control circuit 514 may receive signal information from the radio antenna 570. In a sleep mode, microprocessor 560 with the host circuit 530 is powered OFF or asleep. The radio control circuit 514 may remain powered ON while the microprocessor 560 with host circuit 530 is powered OFF or a low-power sleep mode. The radio controller circuit 514 may listen for BLE advertisement signals, even when the microprocessor 560 with host circuit 530 is in sleep mode. The radio control circuit 514 may store identification information for previously paired remote controllers and use the stored identification information to detect whether a previously paired remote controller is sending a radio advertisement signal. The radio control circuit 514 may wake up the microcontroller 560 with host circuit 530 when a previously paired remote controller is detected.

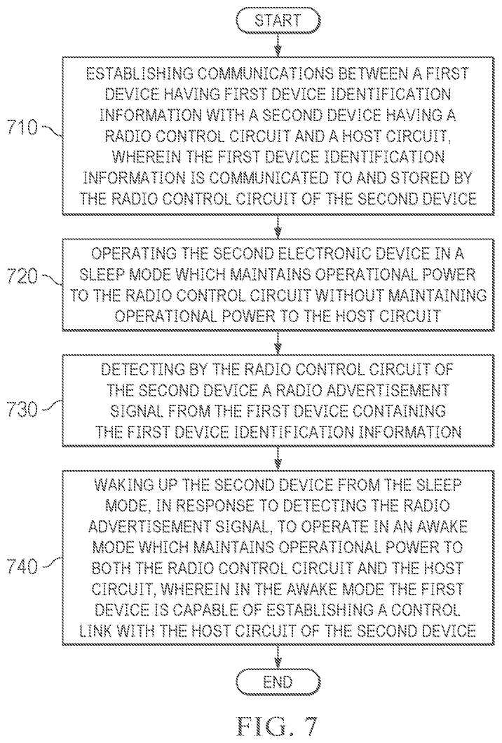

FIG. 6 shows a block diagram of an electronic device 610 having a radio antenna 670 and a microprocessor 660. The microprocessor 660 may have a radio control circuit 614 and a host circuit 630. The microprocessor 660 may receive signal information from the radio antenna 670. In a sleep mode, the host circuit 630 is powered OFF or asleep. The radio control circuit 614 may remain powered ON while the host circuit 630 is powered OFF or in a low-power sleep mode. The radio controller circuit 614 may listen for BLE advertisement signals, even when the host circuit 630 is in sleep mode. The radio control circuit 614 may store identification information for previously paired remote controllers and use the stored identification information to detect whether a previously paired remote controller is sending a radio advertisement signal. The radio control circuit 614 may wake up the host circuit 630 when a previously paired remote controller is detected.

Aspects of this disclosure may be used with any electronic device that may be in a low-power state and then woken-up upon detection of a BLE advertisement from a previously paired remote controller.

An aspect provides a method for controlling an electronic device, such as a television, a headset, or something else. A first device (which may be a smartphone, or something else), is paired with a second device (which may be a television, a headset, or something else). As part of the pairing process, an ID from the first device is communicated to the second device, and stored in the radio control circuit (BLE controller) of the second device. The first device may move away, be shut off, or otherwise disconnect from the second device. After some time in which there is no activity at the second device (from the first device, or from something else, or combination thereof), the second device may go into the low power mode. The first device may again establish communications with the second device, wherein an advertising beacon is broadcast by the first device at pre-determined intervals, which includes the ID of the first device. The second device has a radio control circuit, which may include a scanner, that wakes up on a schedule so as to detect the advertising beacon. However, the balance of the second device is in a low power mode (e.g., a TV in sleep mode). The radio control circuit of the second device receives data from the advertising beacon, and compares the ID from the advertising beacon with the stored ID from the pairing process (there may be multiple devices stored from prior pairing processes). If there is a match, action is to be taken, particularly waking up the balance of the second device from the low power mode.

FIG. 7 shows a flow chart of a method. A first device having first device identification information establishes communications 710 between a second device having a radio control circuit and a host circuit, wherein the first device identification information is communicated to and stored by the radio control circuit of the second device. One way to establish communications is by pairing. The second electronic device is operated 720 in a sleep mode which maintains operational power to the radio control circuit without maintaining operational power to the host circuit. The radio control circuit of the second device detects 730 a radio advertisement signal from the first device containing the first device identification information. The radio control circuit of the second device detects 730, in response to detection of the radio advertisement signal from the first device containing the first device identification information, wakes up 740 at least a portion of the balance of the second device from the sleep mode, in response to detecting the radio advertisement signal, to operate in an awake mode which maintains operational power to both the radio controller and host circuits, wherein in the awake mode the first device is capable of establishing a control link with the host circuit of the second device.

Radio control circuits, radio circuits, host circuits, storage circuits, and comparator circuits may be respectively implemented by instructions in a medium for execution by a processor, a function, library call, subroutine, shared library, software as a service, analog circuitry, digital circuitry, control logic, digital logic circuits programmed through hardware description language, application-specific integrated circuit (ASIC), field-programmable gate array (FPGA), programmable logic device (PLD), or any suitable combination thereof, or any other suitable mechanism, whether in a unitary device or spread over several devices.

In one aspect, the radio control circuit processes radio signals according to Bluetooth Low Energy and WiFi protocols, and the host circuit processes radio signals according to Bluetooth Low Energy protocol.

Although examples have been described above, other variations and examples may be made from this disclosure without departing from the spirit and scope of these disclosed examples.

1. A method comprising:
establishing communications between a first device having first device identification information with a second device having a radio control circuit and a host circuit, wherein the first device identification information is communicated to and stored by the radio control circuit of the second device;
operating the second electronic device in a sleep mode which maintains operational power to the radio control circuit without maintaining operational power to the host circuit;
detecting by the radio control circuit of the second device a radio advertisement signal from the first device containing the first device identification information; and
waking up the second device from the sleep mode, in response to detecting the radio advertisement signal, to operate in an awake mode which maintains operational power to both the radio control circuit and the host circuit, wherein in the awake mode the first device is capable of establishing a control link with the host circuit of the second device.

2. The method of claim 1, comprising establishing the control link between the first device and the host circuit of the second device after detecting by the radio control circuit the radio advertisement signal from the first device containing the first device identification information.

3. The method of claim 1, wherein the first device identification information is communicated via a signal selected from Bluetooth, Wi-Fi, and ZigBee.

4. The method of claim 1, wherein the advertising signal comprises a Bluetooth Low Energy radio signal.

5. The method of claim 1, comprising comparing by the radio control circuit the detected first device identification information contained in the radio advertisement signal from the first device with the stored first device identification information.

6. The method of claim 1, wherein the second electronic device comprises a microprocessor comprising the host circuit and the host circuit comprises a BLE stack.

7. The method of claim 1, wherein the second electronic device comprises a microprocessor comprising the radio control circuit and the host circuit.

8. The method of claim 1, wherein the electronic device is a line powered electronic device.

9. A device comprising:
a radio antenna;
a microprocessor in signal communication with the radio antenna and comprising:
a radio control circuit in communication with the radio antenna to store identification information of a remote controller and detect an advertising signal from a remote controller containing identification information of the remote controller; and
a host circuit in communication with the radio antenna to establish a control link with the remote controller;
wherein the device is operable in a low-power mode wherein operational power is maintained to the radio control circuit and not maintained to the host circuit,
wherein the device is operable in a high-power mode wherein operational power is maintained to both the radio control circuit and the host circuit, and
wherein the device switches from the low-power mode to the high-power mode in response to detection, by the radio control circuit, of a radio advertisement signal containing the identification information of the remote controller.

10. The device of claim 9, wherein the radio control circuit triggers the device to operate in the high-power mode when the radio control circuit detects the radio advertisement signal containing the identification information of the remote controller.

11. The device of claim 9, wherein the remote controller is an application of a smartphone, and the radio control circuit pairs with the smartphone and stores smartphone identification information from the pairing.

12. The device of claim 11, wherein the remote controller is an application of a smartphone, and wherein the radio control circuit pairs with the smartphone by communicating a signal selected from Bluetooth, Wi-Fi, and ZigBee.

13. The device of claim 9, comprising a comparator circuit to compare identification information of the remote controller stored by the radio control circuit with identification information of the remote controller of the radio advertisement signal.

14. The device of claim 9, wherein the radio control circuit processes radio signals according to Bluetooth Low Energy and WiFi protocols, and wherein the host circuit processes radio signals according to Bluetooth Low Energy protocol.

15. The device of claim 9, wherein the device is a line powered electronic device.

16. A system comprising:
a remote controller having remote controller identification information; and
an line powered electronic device comprising:
a radio antenna;
a radio control circuit in communication with the radio antenna, the radio control circuit to store identification information of a remote controller and detect a radio advertisement signal from a remote controller containing the identification information;
a host circuit in communication with the radio antenna, the host circuit to establish a control link with the remote controller;
wherein the radio control circuit to wake-up the host circuit in response to detection, by the radio control circuit, of a radio advertisement signal containing the remote controller identification information.

17. The system of claim 16, wherein the radio control circuit and host circuit are capable of processing radio signals according to Bluetooth Low Energy protocols.

18. The system of claim 16, comprising a comparator circuit capable of comparing remote controller identification information stored by the radio control circuit with remote controller identification information of a radio advertisement signal.

19. The system of claim 16, comprising a microprocessor comprising the radio control circuit and the host circuit.

20. The system of claim 16, wherein the line powered electronic device is capable of operating in a sleep mode, wherein the line powered electronic device is capable of operating in an awake mode, and wherein waking-up the host circuit comprises switching from the sleep mode to the awake mode.
